(19) United States
(12) Patent Application Publication
(10) Pub. No.: US 2013/0170223 A1
(43) Pub. Date: Jul. 4, 2013

(54) Light Diffusion Mechanism

(71) Applicants: Miva Filoseta, Los Angelse, CA (US); Jebraeil Samo, Rowland Heights, CA (US)

(72) Inventors: Miva Filoseta, Los Angelse, CA (US); Jebraeil Samo, Rowland Heights, CA (US)

(21) Appl. No.: 13/542,009

(22) Filed: Jul. 5, 2012

Related U.S. Application Data
(60) Provisional application No. 61/505,851, filed on Jul. 8, 2011.

(51) Int. Cl. G02B 5/02; F21V 3/04

(52) U.S. Cl. CPC G02B 5/02; F21V 3/049
USPC 362/311.01; 359/615

(57) ABSTRACT

A light diffusion mechanism is disclosed. The light diffusion mechanism includes a container that defines a receptacle or chamber in which light from a light source, such as an LED, can be reflected. The light source is located proximate to the chamber so that its emitted light enters the chamber. The light diffusion mechanism includes a cover with a light emitting portion which is aligned with the container of the base. Light from the light source passes through the light emitting portion of the cover which diffuses the light. The light emitting portion includes one or more textured surfaces through which light passes. In one embodiment, a textured surface includes several grooves formed therein that define ridges.

### CROSS-REFERENCE TO RELATED APPLICATION

This application claims priority to and is based on U.S. Patent Application No. 61/505,851, filed Jul. 8, 2011, entitled “Light Diffusion Mechanism,” the entire disclosure of which is incorporated by reference herein in its entirety.

### FIELD OF THE INVENTION

The present invention relates to a mechanism that can be used to diffuse light, and in particular, to a mechanism that can be used to diffuse light from a light source across an area, such as a light-up button or switch or other visual output.

### BACKGROUND OF THE INVENTION

Some conventional electronic devices include a housing and a visible output portion. In some devices, the visible output portion utilizes the illumination of a light source in the housing to create a visible output. One type of visible output portion is a light-up button on an electronic device that is illuminated by a light source, such as a light emitting diode (LED). When the LED is illuminated, the light from the LED is usually concentrated along various beam paths or emission cones from the LED and does not spread evenly by itself. As a result, a hot spot is formed in the structure that is adjacent the LED, particularly if the LED is close to the structure. The hot spot is created by the uneven distribution of light from the LED.

There is a need for a mechanism that diffuses light for a light-up structure. There is also a need for a light diffusion mechanism that spreads the light from one or more light sources to minimize hot spots and achieve a more uniform lighting, while maintaining overall brightness of a visible output portion.

### SUMMARY OF THE INVENTION

The present invention is directed to a light diffusion mechanism that includes a light reflecting structure and a diffusion panel or cover located over the structure. The light reflecting structure may include one or more chambers or receptacles. In some embodiments, the light reflecting structure includes a sleeve which defines a passageway in communication with the chamber. The light diffusion mechanism includes a light source located proximate to each of the chambers or receptacles. In one implementation, a light source is located in the chamber. In another implementation, a light source is located in the sleeve and partially extends into the chamber. In yet another implementation, the light source is located in the sleeve and does not extend into the chamber. In one embodiment, the panel or cover is a translucent diffusion panel that is placed over the one or more chambers or receptacles.

In one embodiment, the light diffusion mechanism takes light from a light source, such as an LED, and diffuses it across an area. In one embodiment, the area about which the light is diffused corresponds to a light-up button for an electronic device. In other words, the output area of the light from the light source is substantially co-extensive with an output area of the housing, such as a light-up button or switch.

Each of the chambers or receptacles is defined by a container into which light from an LED can enter. In one embodiment, the configurations of each container and the chamber that it defines are generally cylindrical. In one embodiment, a width of the container is larger than the depth of the container. The containers can have different configurations, which are based on differences in any one or more of widths, lengths, depths, volume, shape, and/or size of the containers.

In one embodiment, each container includes an opening through which light from an LED may pass. The LED may be placed proximate to the container so that light therefrom can enter the container. The opening for each container through which the light from an LED travels is formed in a side wall of the container. In one embodiment, the LED can be inserted into a sleeve formed on a side wall of the container. In other embodiments, the opening for a container in which an LED is inserted and mounted is formed in a bottom wall of the container.

When the LED is illuminated, the chamber reflects the light from the LED within the chamber. The container has a top end that is open, which is defined by an upper end of a side wall of the container. The chamber redirects some of the light from the LED to the opening at the top end of the chamber.

In one embodiment, the interior of the light chamber has reflective properties. The container defining the chamber may be molded from a reflective material. Alternatively or in addition, an inner surface of the container may be painted or treated with a reflective material, such as a white matte finish.

### BRIEF DESCRIPTION OF THE DRAWINGS

FIG. 1 illustrates a schematic block diagram of an embodiment of a light diffusion mechanism according to the present invention.

FIG. 1A illustrates a cross-sectional view of a portion of a device utilizing a light diffusion mechanism according to the present invention.

FIGS. 1B-1D illustrate different views of alternative embodiments of chambers of light diffusion mechanisms according to the present invention.

FIG. 2 illustrates a side view of an embodiment of a light diffusion mechanism according to the present invention.

FIG. 3 illustrates a top perspective view of the light diffusion mechanism illustrated in FIG. 2.

FIG. 4 illustrates a bottom perspective view of the light diffusion mechanism illustrated in FIG. 2.

FIG. 5 illustrates a top view of a portion of the base illustrated in FIG. 2 with a light emitting device proximate to the container.

FIGS. 5A and 5B illustrate side views of different orientations of light sources relative to the container.

FIG. 6 illustrates a top perspective view of the base illustrated in FIG. 2.

FIG. 7 illustrates a bottom perspective view of the cover illustrated in FIG. 2.

FIGS. 8 and 9 illustrate cross-sectional views of the light diffusion mechanism illustrating the base and the cover coupled together.

FIG. 10 illustrates a perspective view of a light emitting portion or panel member of the light diffusion mechanism illustrated in FIG. 2.

FIGS. 11-13 illustrate different end views and a perspective view of another embodiment of a light emitting portion.

FIG. 14 illustrates a perspective view of another embodiment of a light emitting portion.

FIGS. 15 and 16 illustrate end views of alternative embodiments of light emitting portions.

FIG. 17 illustrates an exploded cross-sectional side view of a light diffusion mechanism according to the present invention.

FIGS. 18 and 19 illustrate top and bottom perspective views of the light diffusion mechanism illustrated in FIG. 17.

FIG. 20 illustrates a top perspective view of a base of the light diffusion mechanism illustrated in FIG. 17.

FIG. 21 illustrates a bottom perspective view of a cover of the light diffusion mechanism illustrated in FIG. 17.

FIG. 22 illustrates a cross-sectional perspective view of the cover illustrated in FIG. 21 taken along a longitudinal axis of the cover.

FIG. 23 illustrates a cross-sectional perspective view of the light diffusion mechanism illustrated in FIG. 17 taken along a longitudinal axis of the light diffusion mechanism.

FIG. 24 illustrates a perspective view of a device using a light diffusion mechanism according to the present invention.

FIG. 25 illustrates an internal view of the device illustrated in FIG. 24 with a portion of the housing removed.

FIGS. 26-28 illustrate perspective views of the light diffusion used with the device illustrated in FIG. 24.

Like reference numerals have been used to identify like elements throughout this disclosure.

### DETAILED DESCRIPTION OF THE INVENTION

In one embodiment, a light diffusion or diffusing mechanism according to the present invention includes a light chamber and a translucent diffusion panel placed over the light chamber. The light chamber defines a chamber or receptacle that is configured to receive light from a light source, such as an LED, therein. The chamber is defined by one or more walls that reflect the light internally within the chamber. The diffusion panel receives the reflected light from the light source and diffuses the light across an area, such as the surface area of a light-up button. The diffusion of the light minimizes light “hot spots,” thereby achieving a more uniform lighting while maintaining overall brightness.

In some embodiments, the structure defining the chamber includes a sleeve coupled thereto which defines a passageway in communication with the chamber. A light source is located proximate to the chamber. In one implementation, a light source is located in the chamber. In another implementation, a light source is located in the sleeve and partially extends into the chamber. In yet another implementation, the light source is located in the sleeve yet does not extend into the chamber.

A light chamber of a light diffusion mechanism may be of any shape or depth. In one embodiment, a light chamber is generally cylindrical and has a larger width than depth. The light chamber has an opening formed in a side thereof through which light from an LED may enter the chamber. The light chamber is structured to reflect the light from the LED and redirect it to an opening located at the top of the chamber.

The interior of the light chamber is generally reflective. The light chamber may be molded from a reflective material. Alternatively or in addition, the inner surface of the light chamber can be painted or treated with a reflective material, such as a white matte finish.

In one embodiment, the top of the light chamber is covered with a translucent diffusion panel. The diffusion panel further diffuses the light from the chamber. In one implementation, the panel may be made of a molded translucent material.

In one embodiment, the diffusion panel includes at least one light emitting portion or panel portion that includes a saw-tooth cross section texture or light control pattern on each side of the panel. The saw-tooth lines for each side may be perpendicular to the lines on the opposite side. In an alternative embodiment, the saw-tooth shape of the lines may be more of a stair-step shape, which enhances the light diffusion. Various embodiments of different textures that can be provided on a surface of the light emitting portion are described in detail below.

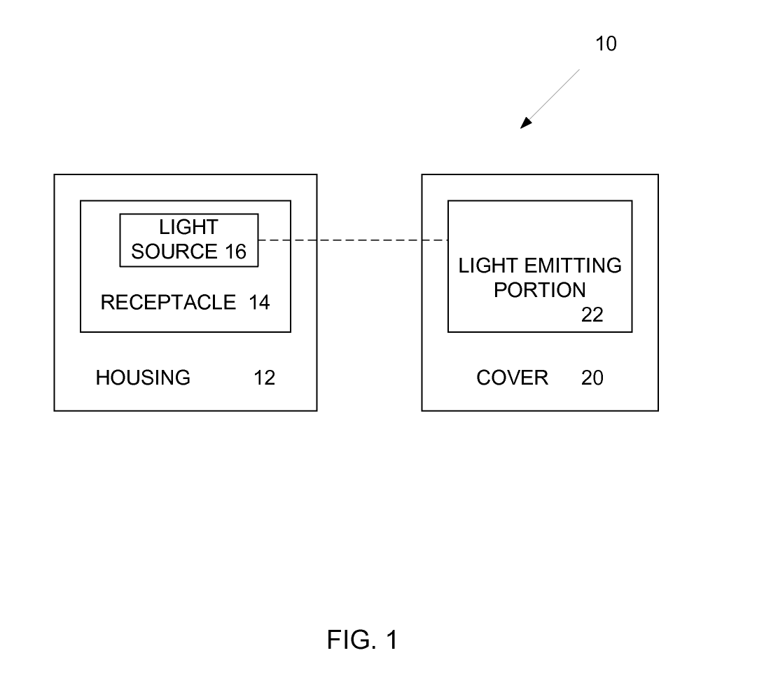

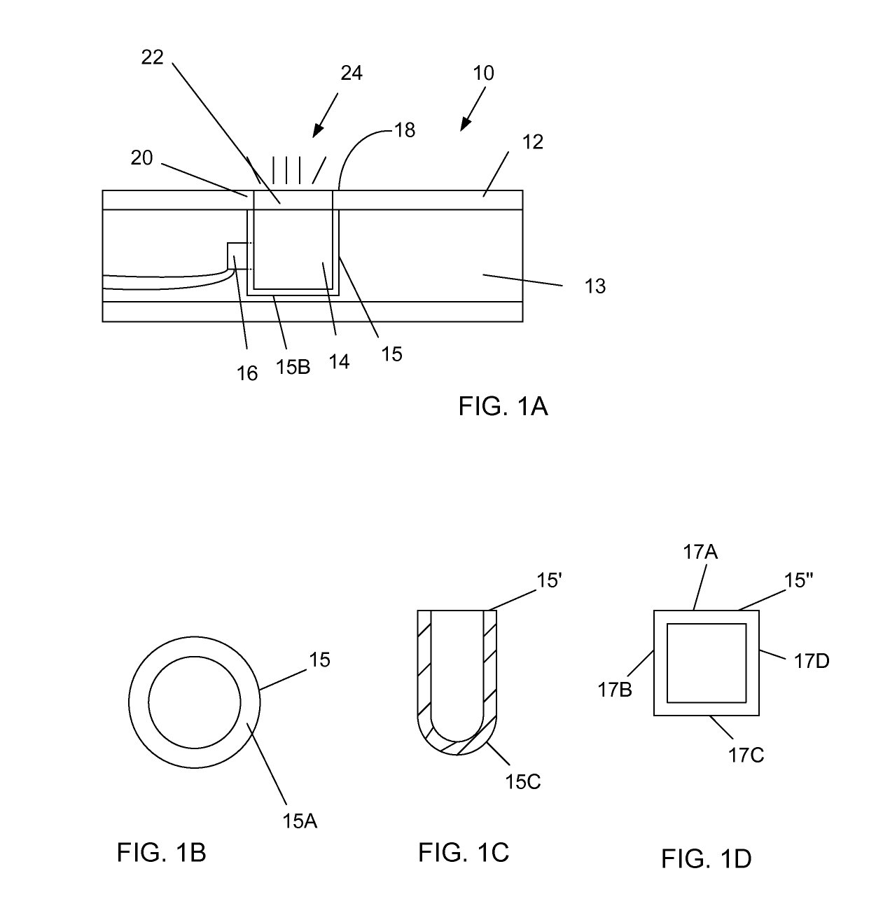

Referring to FIG. 1, a schematic block diagram of a light diffusion mechanism according to the present invention is illustrated. In this embodiment, the light diffusion mechanism 10 includes a housing 12 that defines a receptacle or chamber 14. A light source 16 is located proximate to the receptacle 14 of the housing 12 so that light from the light source 16 enters the chamber. The chamber 14 has one or more reflective surfaces that reflect the light incident thereon within the chamber 14.

In one embodiment, the housing 12 may include a sleeve or mounting structure defining a passageway in communication with the chamber 14. In that embodiment, the light source 16 may be located in the passageway of the sleeve and oriented so that light from the light source 16 enters the receptacle 14. While only one receptacle 14 is illustrated, the housing 12 may include multiple receptacles 14 and light sources 16.

The mechanism 10 also includes a cover 20 that has a light emitting portion 22. The cover 20 can be placed proximate to and/or in contact with the housing 12 so that the light emitting portion 22 is aligned with the receptacle 14. The light emitting portion 22 can have one or more surface variations that affect the passage of light through the light emitting portion 22 of the cover 20. The surface variations enhance the diffusive properties of the light emitting portion 22, thereby creating a more uniform light output from the portion 22.

One type of surface variation is a texture or light control pattern formed on one or more surfaces of the light emitting portion 22. As described in greater detail below, a texture or light control pattern can include one or more grooves, ridges, notches, recesses, and/or projections formed in or coupled to the light emitting portion 22. Alternatively, the textured surface can be a frosted surface. In one implementation, a surface can be sand blasted to create the frosted texture on the surface.

When the LED is illuminated, light from the LED enters the chamber. The reflective surfaces of the chamber cause internal reflection within the chamber of the light. The reflected light is incident upon part of the light emitting portion, which may be a diffusive panel. The light is refracted and reflected by the light emitting portion by the surface variations. The result is that light output from the light emitting portion appears relatively uniform across the surface of the light emitting portion.

Referring to FIG. 1A, an exemplary device with which a light diffusion mechanism according to the present invention can be used is illustrated. The device 10 can be a housing for a game, a toy vehicle, a doll body, an electronic device, or other object. The housing 12 includes an interior region or area 13 and a container 15 located therein. The container 15 includes walls that define a receptacle or chamber 14. A light source 16, such as an LED, is located proximate to the container 15 so that light from the LED 16 enters the chamber 14. The inner surfaces of the chamber 14 reflect the light within the chamber 14.

A diffusing member or panel 22 is located at one end of the chamber 14. In this embodiment, the diffusing member 22 can be positioned near or inserted into the opening 20 defined by edge 18. When the LED 16 is illuminated, the light therefrom reflects off the surfaces defining the chamber 14 and passes through the diffusing member 22. As described below, one or more of the surfaces of the diffusing member 22 is textured so that the light is diffused and emitted from the diffusing member 22 in a more uniform manner as light 24.

In an alternative embodiment, a translucent cover may be located outside of the diffusing member 22 in the opening 20. In this arrangement, light from the diffusing member 22 passes through the cover as well.

In one embodiment, the container 15 is cylindrical with a continuous side wall 15A as shown in FIG. 1B and a generally flat bottom wall 15B as shown in FIG. 1A. In an alternative embodiment, the container 15′ may have a rounded bottom wall 15C as shown in FIG. 1C. In another embodiment, instead of having a circular cross-section, the container 15″ may be formed with multiple side walls 17A, 17B, 17C, and 17D that form a square or rectangular cross-sectional shape as shown in FIG. 1D. In other embodiments, the shape of the container and the receptacle defined by the container can vary.

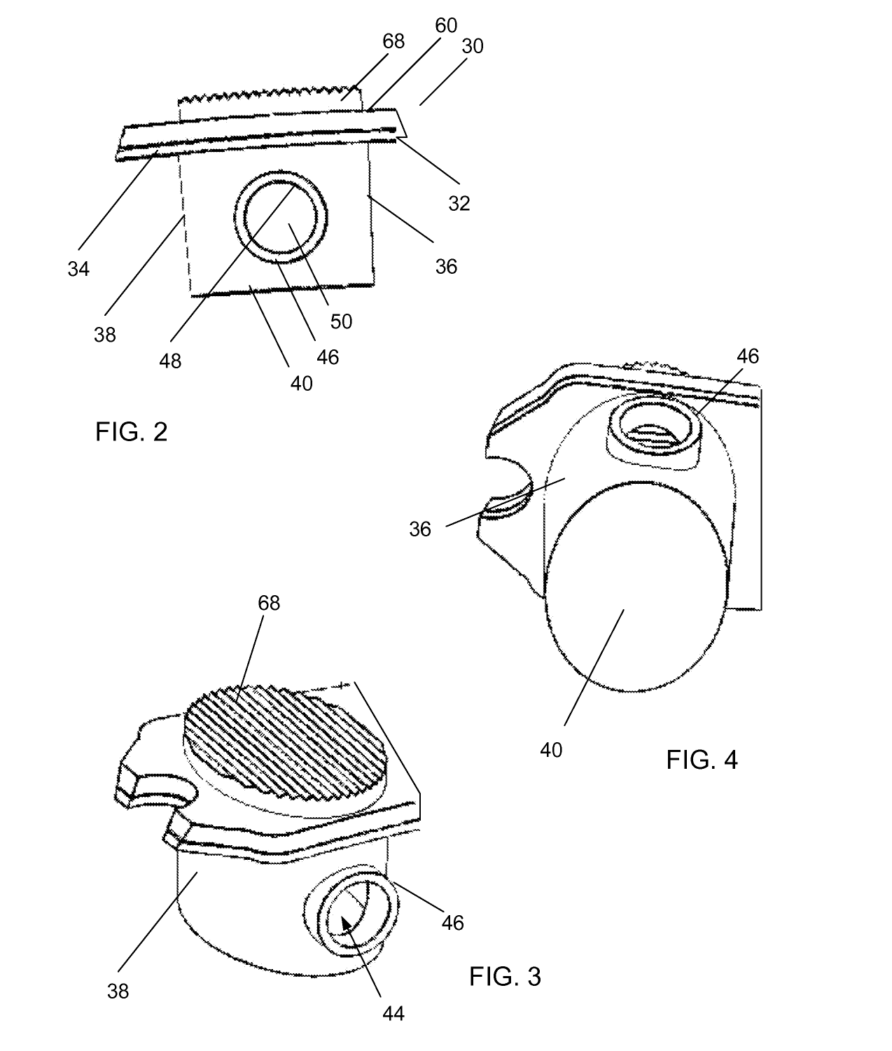

Referring to FIGS. 2-10, an embodiment of a light diffusion mechanism according to the present invention is illustrated. Referring to FIG. 2, the light diffusion mechanism 30 includes a base 32 and a cover 60 coupled to the base 32. The base 32 includes a plate 34 and a container or housing 36 that is coupled to the plate 34. In one embodiment, the plate 34 and the container 36 are formed together, such as by molding.

The housing 36 includes a side wall 38 that has a cylindrical configuration and a bottom wall 40 coupled to the side wall 38 (see FIG. 4). The side wall 38 and the bottom wall 40 define a receptacle or chamber 44 (see FIG. 3).

As shown in FIGS. 2-4, a sleeve 46 is coupled to and extends outwardly from the side wall 38. The side wall 38 includes an inner wall surface 48 that defines a passageway 50. The passageway 50 is in communication with the chamber 44. In one embodiment, the passageway 50 has a diameter that permits the insertion of a light source, such as an LED. Light from the light source mounted or inserted in the passageway 50 of the sleeve 46 enters the chamber 44. While the sleeve is illustrated as being cylindrical, in other embodiments, the cross-sectional shape of the sleeve can vary.

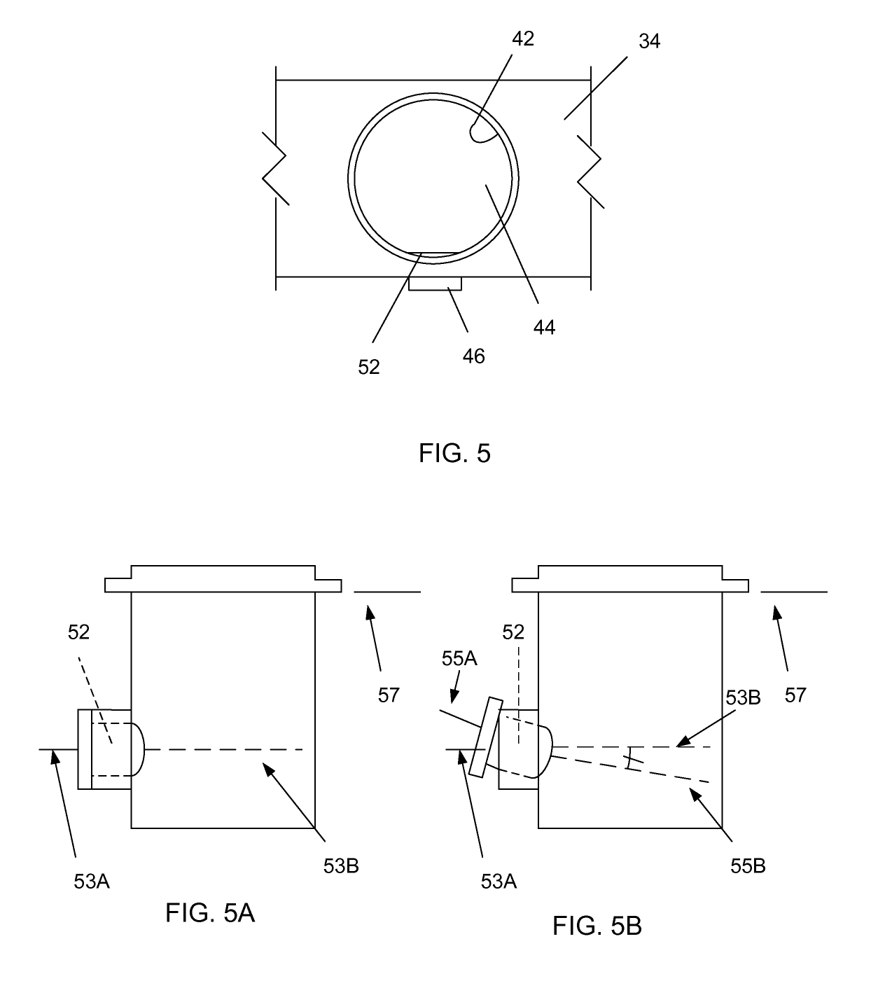

In one embodiment, as shown in FIG. 5, the light source 52 can extend slightly into the chamber 44 defined by the side wall inner surface 42. In particular, the semiconductor die within the LED is co-planar with the inner surface of the side wall defining the chamber 44. As a result, a portion of the epoxy lens covering the semiconductor die may extend into the chamber 44. However, as illustrated, a substantial portion of the light source 52 remains contained within the passageway 50 of the sleeve 46. Keeping the semiconductor die of the LED within the passageway 50 of the sleeve 46 and/or outside of the chamber 44 may aid in minimizing the appearance of a “hot spot” within the chamber 44, which is a concentrated area of light within an illuminated area such as the light emitting portion 22 of a cover 20.

Referring to FIGS. 5A and 5B, different side views of the container 36 is illustrated. In FIG. 5A, a longitudinal axis 53A of the LED 52 is illustrated as well as a central axis 53B of light from the LED 52. Also, axis 53B is the central axis of the passageway defined by the sleeve as well as the sleeve. While light may be emitted from the LED 52 in a variety of dispersion patterns, axis 53B is used as the generally central axis of the light from the LED 52 and is aligned with the axis 53A of the LED 52. In this orientation of the LED 52, axis 53B extends substantially horizontal and generally parallel to the plane 57 along which the cover extends. The orientation of the LED 52 relative to the container may be adjusted so that the light from the LED 52 enters the receptacle at an angle offset from a substantially horizontal orientation.

Referring to FIG. 5B, the LED 52 has been manipulated so that the semiconductor die faces downwardly slightly with the LED's axis 55A offset from axis 53A and its central light axis 55B is offset from axis 53B. By introducing light into the chamber at an angle other than at horizontal orientation directly at the inner wall surface across the chamber, the reflection of light around in the chamber may be enhanced. In another embodiment, the LED 52 can be oriented to point upward relative to axis 53B.

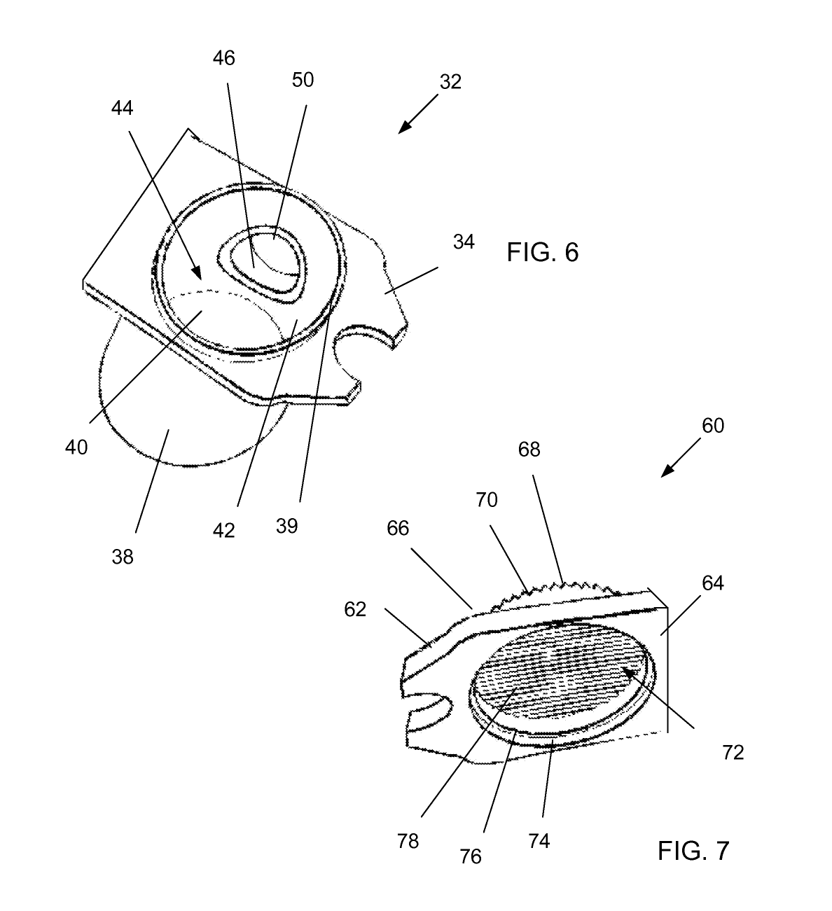

Referring to FIG. 6, a top perspective view of the base 32 with the cover 60 removed is illustrated. As shown, the chamber 44 is defined by surface 42 of the side wall 38 and the bottom wall 40. As mentioned above, the passageway 50 of the sleeve 46 is in communication with the chamber 44. In this embodiment, the top end 39 of the side wall 38 extends above the upper surface of the body or plate 34 of the base 32.

Referring back to FIGS. 2 and 3, the cover 60 includes a light emitting portion or panel member 68 through which light in the chamber 44 exits the light diffusion mechanism 30. The light emitting portion 68 may be referred to alternatively as a light output portion. The light emitting portion 68 is aligned with the chamber 44 when the cover 60 is coupled to the base 32.

Referring to FIG. 7, a bottom perspective view of the cover 60 is illustrated. The cover 60 includes a body 62 with a lower surface 64 and an upper surface 66. In this embodiment, the light emitting portion 68 is in a plane that is offset from the plane along which the plate 62 extends. The light emitting portion 68 has an outer surface 70 and an inner surface 72 opposite surface 70. Each of the surfaces 70 and 72 is textured to increase the diffusion of light and improve the uniformity of light emitted from portion 68. The offset position of the light emitting portion 68 relative to the plate 62 forms a recess 78 as shown in FIG. 7. In addition, around the recess 78 is an edge or wall 74 in which a groove 76 is formed.

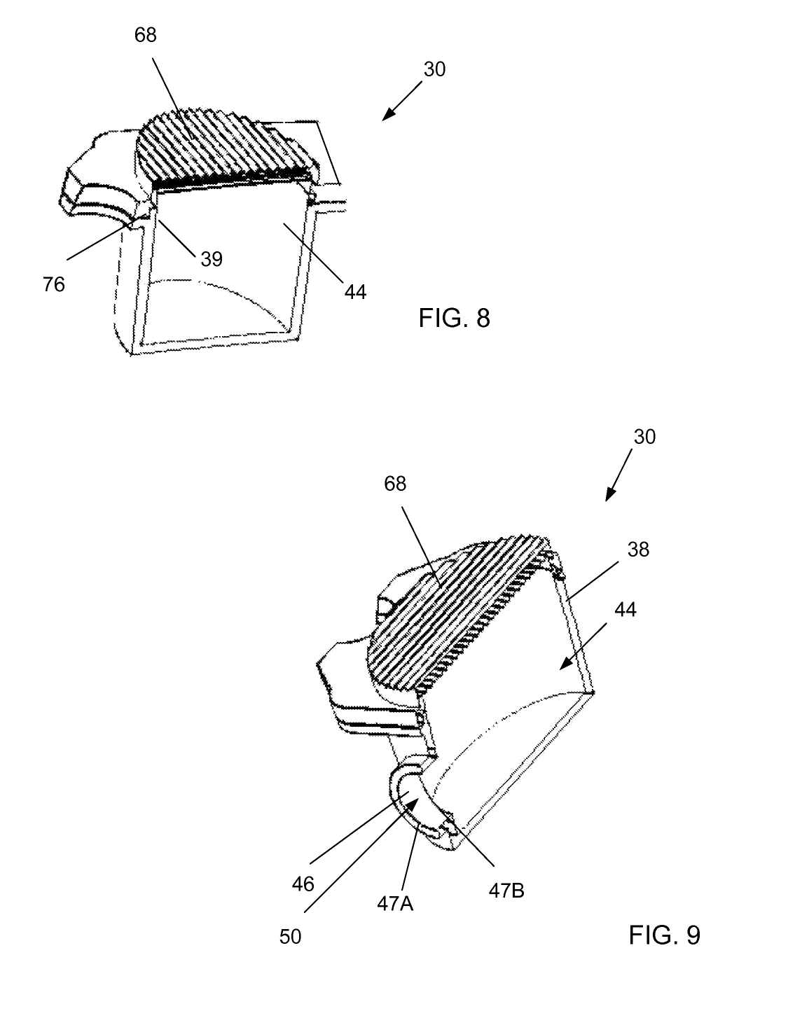

When the cover 60 is coupled to the base 32, the upper end 39 of side wall 38 is inserted into the groove 76 (see FIGS. 8 and 9). The engagement of the upper end 39 in the groove 76 ensures that light reflected in chamber 44 is output only through light emitting portion 68. In one embodiment, the sleeve 46 has an outer end 47A and an inner end 47B along passageway 50. The light source is inserted in the passageway 50 and is configured to mate with the inner wall of the sleeve 46. The outer diameter of the light source is substantially the same as the inner diameter of the sleeve 46, thereby preventing the passage of any light from the light source through the sleeve 46.

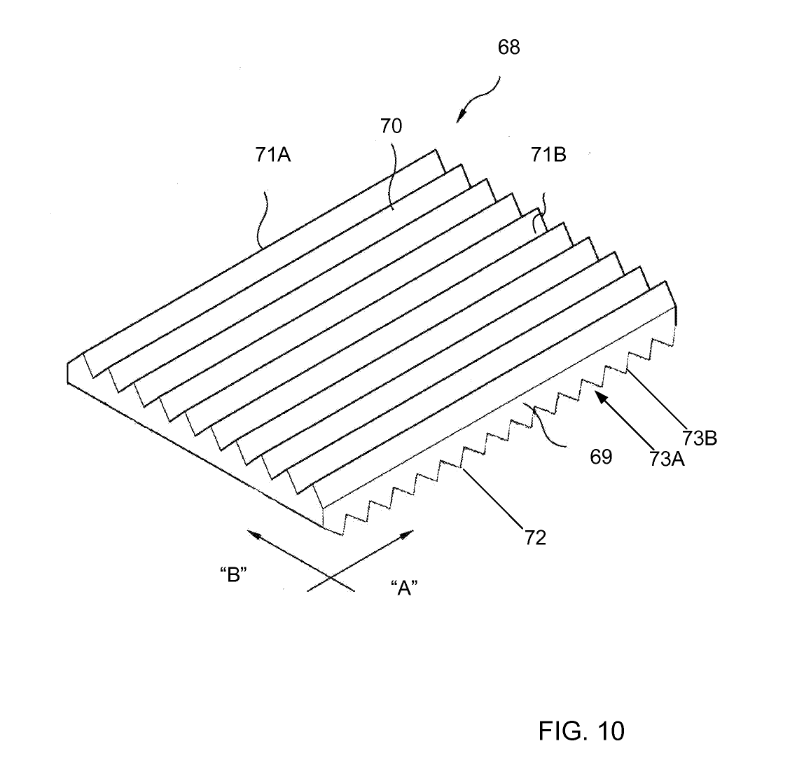

Referring to FIG. 10, a portion of the light emitting portion 68 is illustrated. In this embodiment, the outer surface 70 of the body 69 of the light emitting portion 68 includes several parallel grooves 71B that define ridges 71A therebetween. The grooves 71B extend across the outer surface 70 along the direction of arrow “A.” The inner surface 72 of the light emitting portion 68 includes several parallel grooves 73B that define ridges 73A therebetween. The grooves 73B extend across the inner surface 72 along the direction of arrow “B,” which is orthogonal to the direction of arrow “A.” As a result, ridges 71A in outer surface 70 extend orthogonal to ridges 73A in inner surface 72.

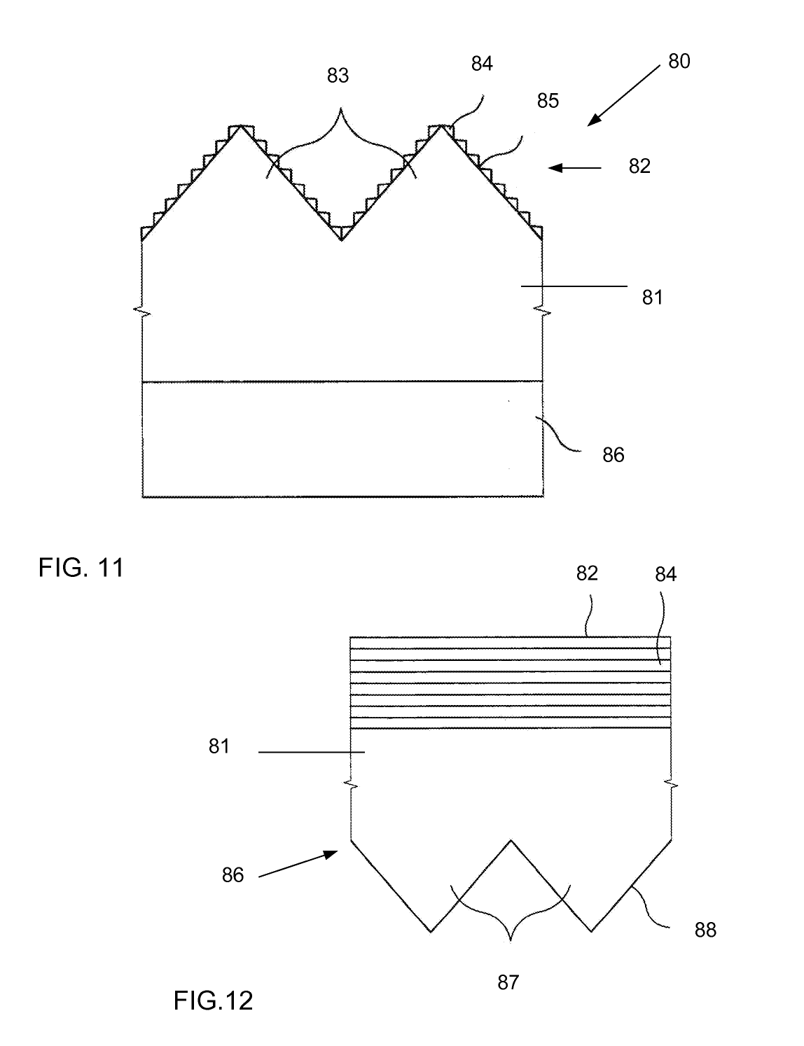

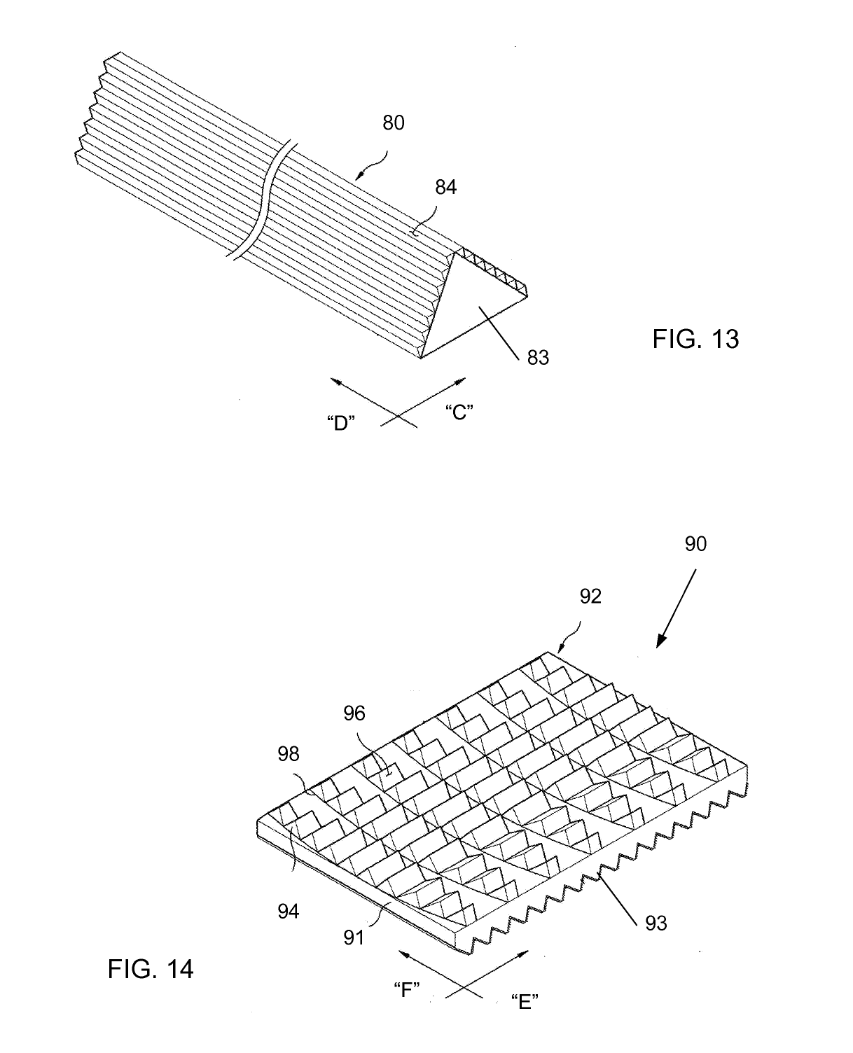

Referring to FIGS. 11-13, an alternative embodiment of the light emitting portion is illustrated. The views illustrated in FIGS. 11 and 12 are orthogonal to each other. In this embodiment, the light emitting portion 80 includes a body 81 with an upper surface 82 with several ridges 83, each of which includes several teeth or prisms 84 that are formed by notches or grooves 85 therebetween. Referring to FIG. 12, the body 81 also includes a lower surface 86 that has ridges 87 formed by sloped surfaces 88. As shown in FIG. 13, ridge 83 and its teeth or prisms 84 extend along the direction of arrow “D.” Ridges 87 extend along the direction of arrow “C” in FIG. 13. Similar to the embodiment illustrated in FIG. 10, the ridges 83 in surface 82 are orthogonal to the ridges 87 in surface 88.

Referring to FIG. 14, another embodiment of a light emitting portion is illustrated. In this embodiment, light emitting portion 90 includes a body 91 with an upper surface 92 and a lower surface 93. The upper surface 92 includes several different rows of teeth or prisms that have varying sizes and sloping surfaces. For example, rows 94, 96, and 98 are illustrated and extend along the direction of arrow “E.” In different embodiments, the configuration and quantity of the rows in the upper surface 92 and the surfaces in each of the rows can vary. The lower surface 93 may include several ridges and grooves that extend across the surface along the direction of arrow “F.”

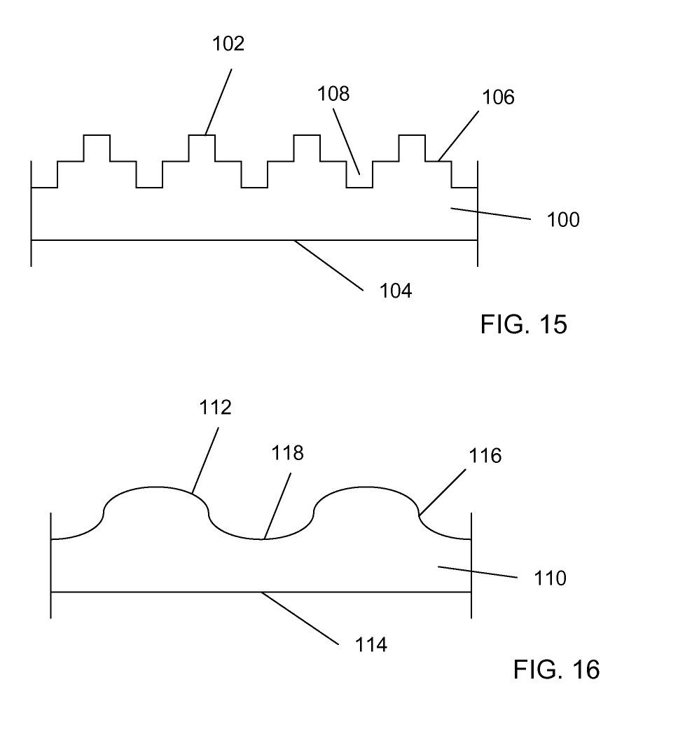

Referring to FIGS. 15 and 16, different embodiments of a panel portion according to the present invention are illustrated. In FIG. 15, the panel portion 100 has an outer surface 106 and an inner surface 104. Each of the ridges 102 formed in the outer surface 106 has a stepped configuration that defines correspondingly shaped grooves 108 on opposite sides thereof. The inner surface 104 may include a similar surface texture disposed at an angle, such as 90°, relative to the texture on the outer surface 106.

In FIG. 16, panel portion 110 has an outer surface 116 and an inner surface 114. The outer surface 116 has several rounded ridges 112 separated by grooves 118 as shown. The inner surface 114 has a similar configuration of ridges and grooves to those on outer surface 116.

In alternative embodiments, the size, the shape, and/or the configuration of the textures in the outer surface of a panel member can be different than the size, the shape, and/or the configuration of the textures in the inner surface of the panel member. For example, the outer surface textures can be larger or smaller than the inner surface textures. Alternatively, the spacing between adjacent outer surface textures can be greater or less than the spacing between adjacent inner surface textures. Also, the types of outer surface textures can be different than the types of inner surface textures. In addition, in different embodiments, the textures of either or both the inner surface and the outer surface of a panel member may include curved and/or linear portions. Also, as mentioned above, the surfaces may be frosted.

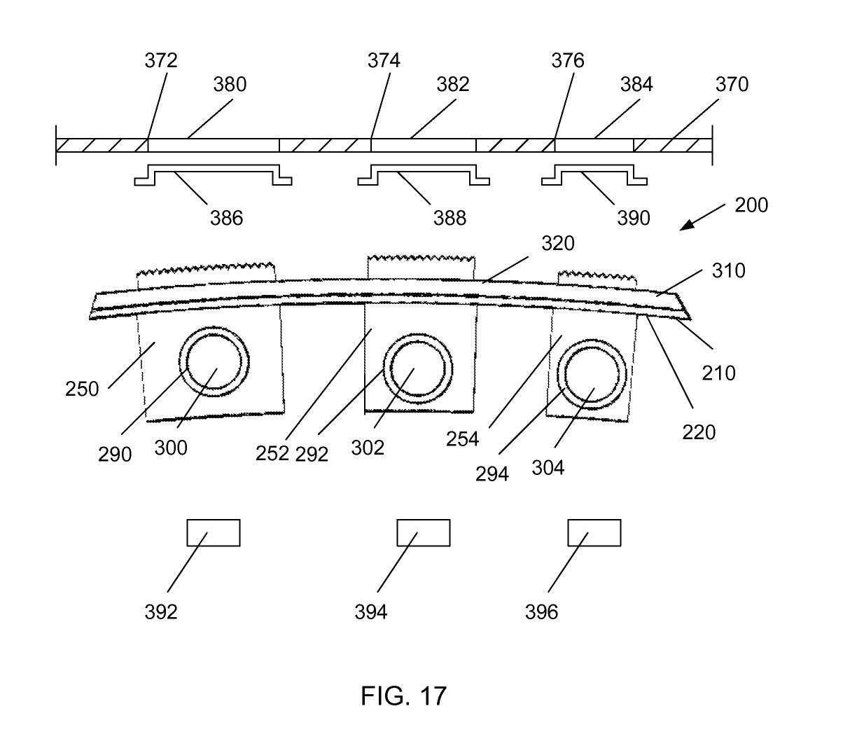

Referring to FIG. 17, an embodiment of a light diffusion mechanism according to the present invention is illustrated. In this embodiment, the light diffusion mechanism 200 includes a base 210 and a cover 310. As shown, the cover 310 can be coupled to and placed in contact with the base 210. The base 210 and the cover 310 have substantially the same length and width as each other.

In one exemplary implementation, the light diffusion mechanism 200 can be located in a housing of a device. For example, the device can be used to play a game that involves the generation of one or more visible outputs. In FIG. 17, a partial cross-section of a portion of an exemplary housing 370 is illustrated. The housing 370 includes several inner edges 372, 374, and 376 that define openings 380, 382, and 384 that extend through the wall of the housing 370. While three openings 380, 382, and 384 are illustrated in FIG. 17, in other implementations, the housing 370 may include a single opening or two or more openings formed therein.

In an alternative embodiment, covers 386, 388, and 390 can be placed so as to engage the openings 380, 382, and 384, respectively. In one implementation, the covers 386, 388, and 390 can be fixedly coupled to the housing 370 so that the covers 386, 388, and 390 do not move relative to the housing 370. In another implementation, the covers 386, 388, and 390 can be mounted for movement relative to the openings in the housing 370, and can be associated with switches (not shown) that are closed in response to the movement by a user of a corresponding cover associated with a switch (such as by pressing on the cover). In different implementations, all or a portion the covers 386, 388, and 390 may be translucent or transparent and may or may not include any markings or indicia thereon.

In this embodiment, the base 210 of the light diffusion mechanism 200 includes a plate or body 220. Similarly, the cover 310 includes a plate or body 320 that corresponds generally in width and length to plate 220 of the base 210. The plates 220 and 320 may have a slightly curved configuration, depending on the particular implementation of the light diffusion mechanism 200 and the configuration of the housing in which the light diffusion mechanism 200 is located.

The plate 220 of the base 210 includes three containers 250, 252, and 254 coupled thereto. In one embodiment, the plate 220 is an integrally molded piece, with the containers 250, 252, and 254 formed with the plate 220.

In this embodiment, container 250 is slightly larger than container 252, which is slightly larger than container 254. As the containers 250, 252, and 254 are generally cylindrical, the diameters of the containers 250, 252, and 254 vary. The diameter of container 250 is larger than the diameter of containers 252 and 254, and the diameter of container 252 is larger than the diameter of container 254. Generally, the length of the containers 250, 252, and 254, which is the distance that the containers extend from base plate 220, is substantially the same for each container.

Referring to FIG. 17, container 250 includes a sleeve 290 that defines an opening 300 into which a light emitting device, such as an LED 392, can be inserted so that the LED 392 is located proximate to the chamber of the container 250. Similarly, container 252 includes a sleeve 292 that defines an opening 302 and container 254 includes a sleeve 294 that defines an opening 304. LEDs 394 and 396 are inserted into the openings 302 and 304, respectively, as well.

In one embodiment, for container 250, the center point of the opening 300 defined by sleeve 290 is located along the side wall at a distance that is approximately half of the length that the side wall of container 250 extends from plate 220. The center points of openings 302 and 304 defined by sleeves 292 and 294 are located at distances that are approximately forty percent (40%) of the length of the side walls of the containers 252 and 254 as measured from the bottom walls of the containers 252 and 254. The location of the sleeves and their openings determine the location at which light is introduced into the chambers, which affects the reflection of the light in the chamber and the resulting light output from the light diffusion mechanism.

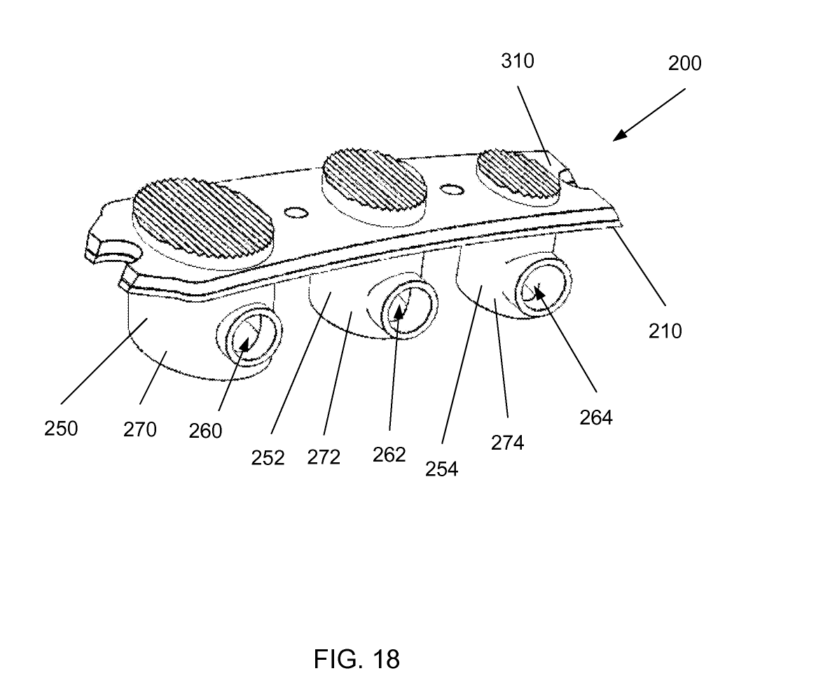

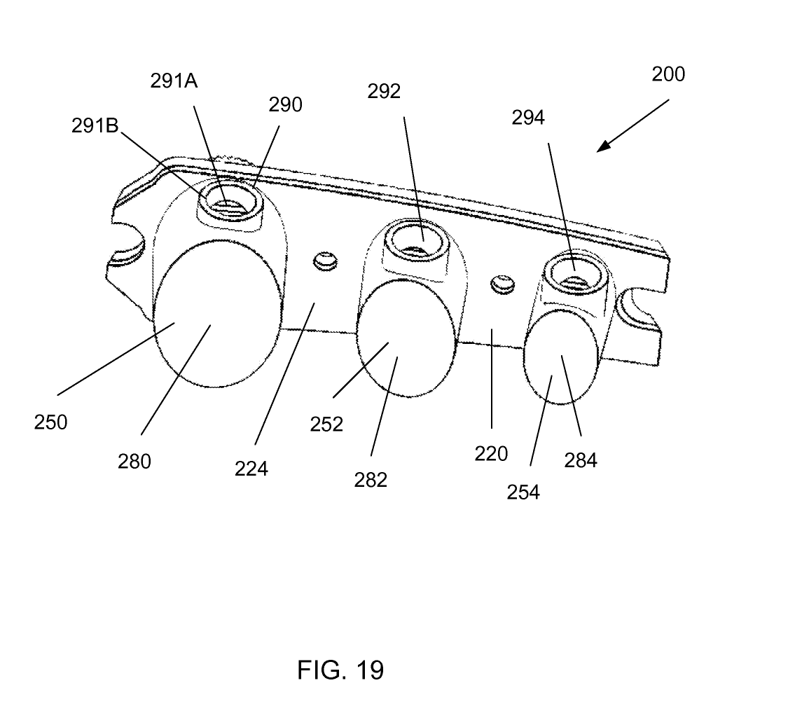

Referring to FIGS. 18 and 19, perspective views of light diffusion mechanism 200, including the base 210 and cover 310, are illustrated. As shown, container 250 includes a generally cylindrical side wall 270 that extends from a lower surface 224 (see FIG. 19) of the plate 220. The container 250 also includes a bottom wall 280 located at the bottom end of the side wall 270. The side wall 270 and the bottom wall 280 collectively define a receptacle or chamber 260 into which light from an LED passes.

Similarly, container 252 has a side wall 272 and a bottom wall 282 which define a receptacle 262 and container 254 has a side wall 274 and a bottom wall 284 which define a receptacle 264. An LED can be placed or disposed proximate to each of the receptacles 262 and 264 as well. While the side walls 270, 272, and 274 are generally cylindrical, in different embodiments, the configuration of the side walls 270, 172, and 274 can vary and may include several facets or surfaces, e.g. in a rectangular configuration.

As shown in FIG. 19, sleeve 290 extends outwardly from the side wall 270 of container 250. The sleeve 290 includes an inner end 291A and an outer end 291B. The opening or passage defined by the sleeve 290 between ends 291A and 291B is in communication with the receptacle or interior region 260 of the container 250. Similarly, sleeve 292 has an inner end and an outer end and sleeve 294 has an inner end and an outer end.

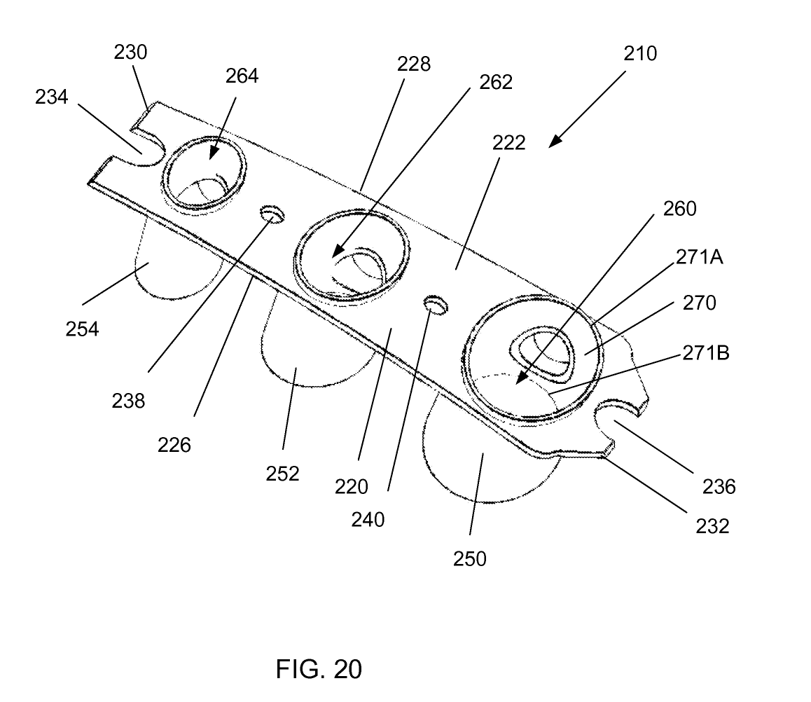

Referring to FIG. 20, the cover 310 of the light diffusion mechanism 200 has been removed from the base 210 for ease of reference. The receptacles 260, 262, and 264 of the containers 250, 252, and 254, respectively, are illustrated.

The plate 220 includes an upper or outer surface 222. Surface 222 is referred to as an outer surface because the surface 222 is oriented or faces outwardly relative to a housing in which the light diffusion mechanism is located. Accordingly, surface 224 of plate 220 is oriented or faces inwardly relative to a housing.

The plate 220 also includes opposite sides 226 and 228, and opposite ends 230 and 232. End 230 includes a notch 234 and end 232 includes a notch 236. The notches 234 and 236 are used for aligning and retaining the light diffusion mechanism 200 within a housing or device. The light diffusion mechanism 200 can be positioned so that alignment structures associated with the housing can engage the notches 234 and 236. The plate 220 also includes one or more openings 238 and 240 that extend through the plate 220. Each of the openings 238 and 240 is configured to receive a connector, such as a screw, therethrough to mount or couple the plate 310 and the base 210 together. In addition, the connectors inserted into openings 238 and 240 can be used to couple the base 210 and the plate 310 to one or more mounting structures in a housing.

As illustrated in FIG. 20, side wall 270 of container 250 has an upper end 271A and a lower end 271B. The bottom wall 280 is coupled to the lower end 271B of the side wall 270. In this embodiment, a portion of the side wall 270, in particular the upper end 271A, extends above the outer surface 222 of the plate 220. This extension of the side wall 270 mates with a corresponding receptacle or recess on the cover 310. The upper end 271A defines an opening of the container 250 through which light can exit the container 250.

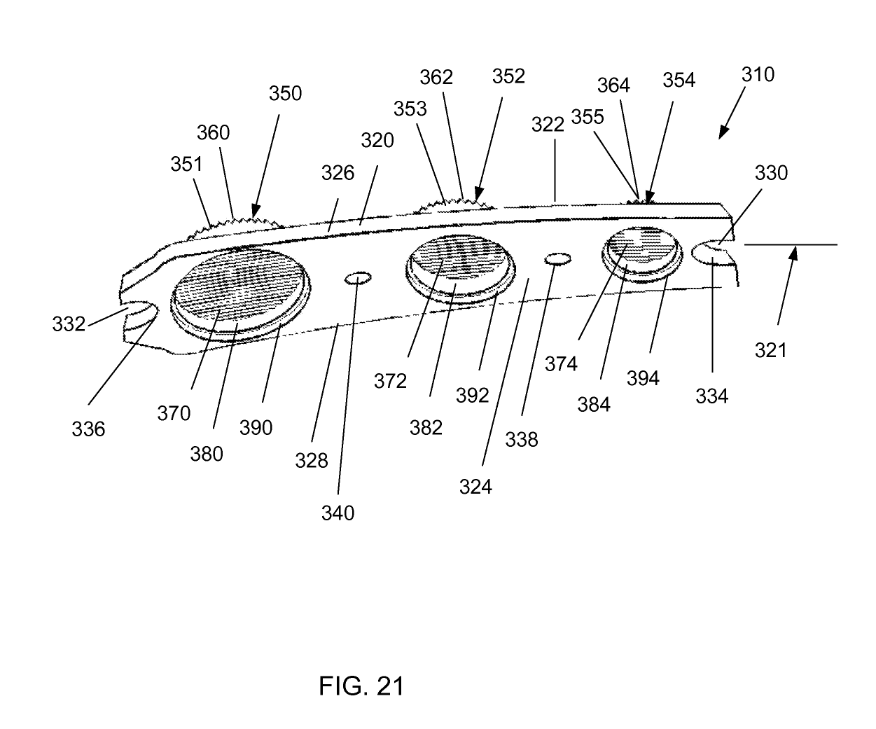

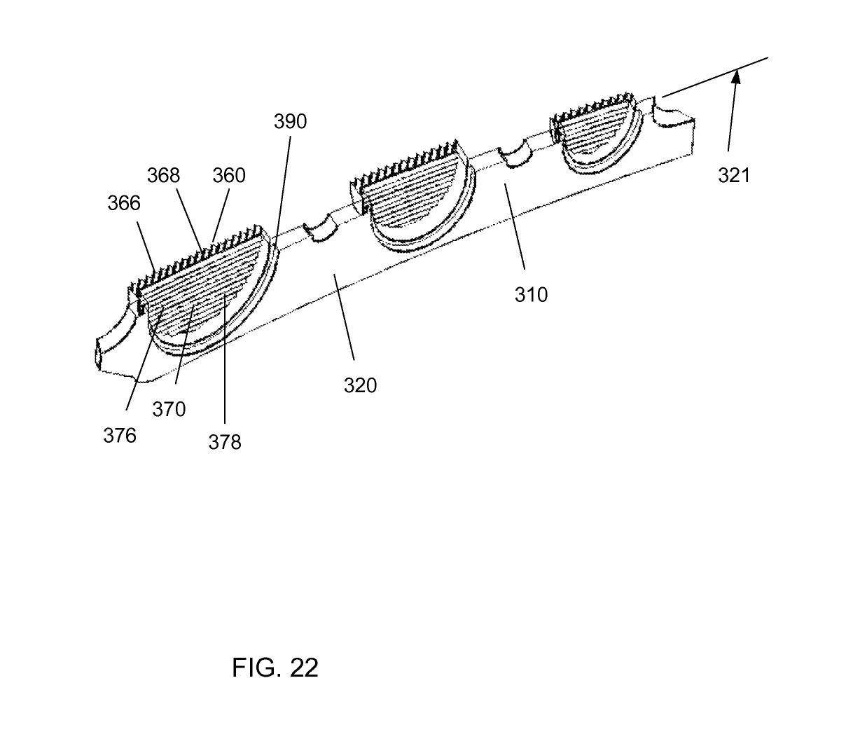

Referring to FIGS. 21 and 22, an embodiment of the cover 310 of the light diffusion mechanism 200 is illustrated. As shown, the plate or body 320 of the cover 310 is a molded piece of material that has a longitudinal axis 321 and opposite outer surface 322 inner surface 324. The plate 320 has opposite sides 326 and 328 and opposite ends 330 and 332 with respective notches 334 and 336. The notches 334 and 336 are aligned with the notches 234 and 236 of the base plate 220 and are used in the same manner. The plate 320 also includes mounting holes or openings 340 and 338.

In this embodiment, the cover 310 includes three light emitting portions 350, 352, and 354. In other embodiments, the quantity of light emitting portions formed in the cover can vary so long as each container of the base 210 that includes a light source has a corresponding light emitting portion.

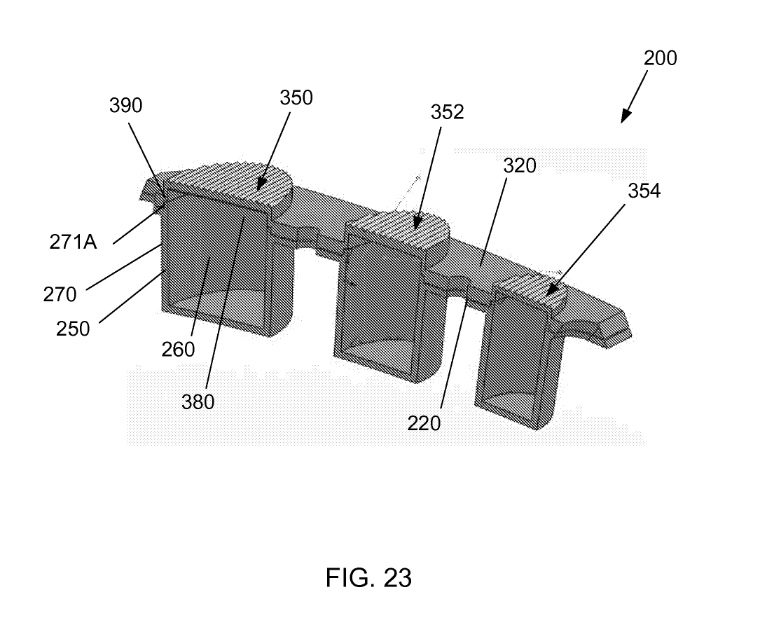

Referring to FIGS. 21 and 23, light emitting portion 350 includes a panel portion 351 that is located in a plane that is offset from a plane in which the plate 320 of the cover 310 is located. The offset configuration of the panel portion 351 defines a recess 380 with a rim or groove 390 extending around an inner perimeter thereof. The groove 390 provides a stepped configuration in the recess 380. The diameter of the groove 390 corresponds to the outer diameter of the upper end 271A of side wall 270 of container 250. As a result, the upper end 271A that extends from the upper surface 222 of plate 220 can be inserted or seated into or mated with the groove 390 of light emitting portion as illustrated in FIG. 23. The engagement of the side wall 270 with the recess 380 enhances the amount of light emitted from the light source in the container 250 beneath light emitting portion 350 through the panel portion 351 because light is not allowed to exit the chamber 260 except through panel portion 351.

Similarly, light emitting portions 352 and 354 have panel portions 353 and 355, recesses 382 and 384, and grooves 392 and 394, respectively, that correspond to panel portion 351, recess 380, and groove 390. The upper ends of side walls 272 and 274 engage the grooves 392 and 394, respectively, as well.

Each of the panel portions 351, 353, and 355 includes an outer surface 360, 362, and 364 and an inner surface 370, 372, and 374. The light in each of the chambers or containers is incident upon the correspondingly aligned inner surface 370, 372, or 374. In one embodiment, each of the surfaces of the panel portions 351, 353, and 355 is textured or contains a light control portion. The textures or light control patterns formed in the outer surfaces 360, 362, and 364 are aligned with each other along a common direction. Similarly, the textures or light control patterns formed in the inner surfaces 370, 372, and 374 are aligned with each other along a common direction. The direction of the textures or light control patterns in an outer surface is offset from the direction of the textures in a corresponding inner surface. In addition, the light control patterns (such as the ridges or grooves) in the outer surfaces 360, 362, and 364 are oriented along the same general direction and are substantially aligned with each other. Similarly, the light control patterns in the inner surfaces 370, 372, and 374 are oriented along the same general direction and are substantially aligned with each other.

Referring to FIG. 22, a cross-sectional view of plate 320 of base 310 taken along the longitudinal axis 321 of the plate 320 is illustrated. The stepped rim or groove 390 is shown in FIG. 22. In this embodiment, the directions of the textures on corresponding outer surfaces and inner surfaces are offset from each other by 90°. As shown in FIG. 22, the outer surface 360 includes grooves 366 that define ridges 368 therebetween and the inner surface 370 includes grooves 376 that define ridges 378 therebetween. In other embodiments, the angle between the directions can be an angle other than 90°. The offset orientation of the textures formed in the outer surfaces and inner surfaces enhances the diffusion of light that passes through the panel portion because of the different angles formed in the surfaces.

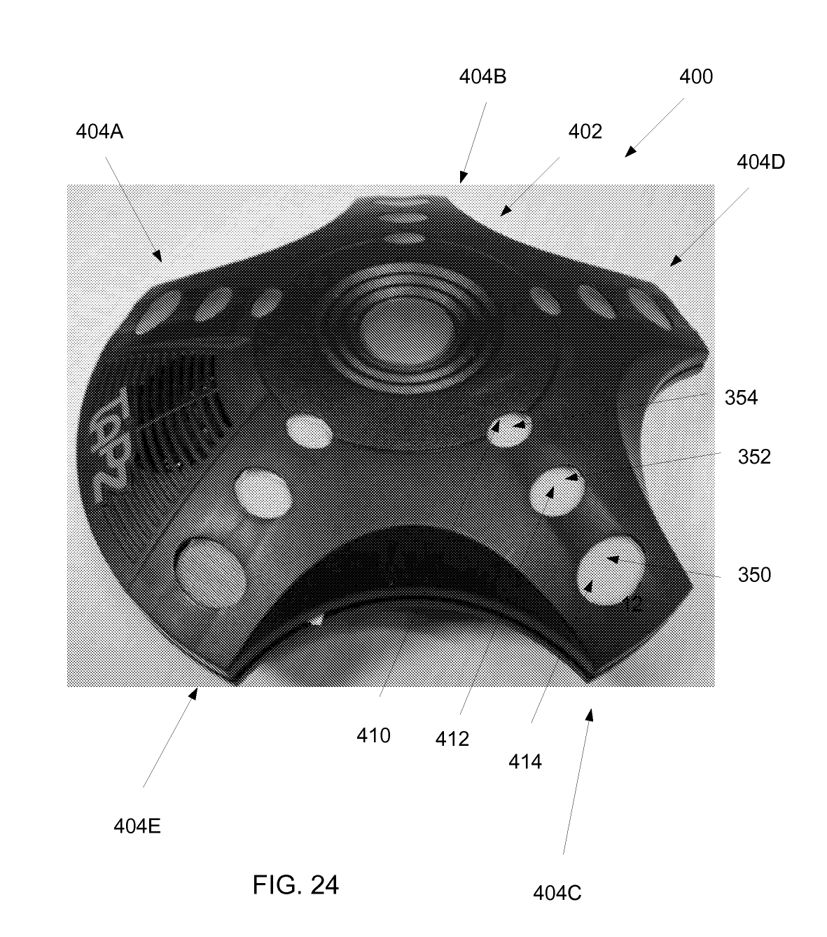

Referring to FIG. 24, an exemplary device with which a light diffusion mechanism according to the present invention can be used is illustrated. The device 400 can be used to play a game that involves the timing of actions by one or more players. In one mode of operation, the device 400 generates visual outputs, such as the illumination of lights, and the players have to take an action relative to the visual outputs.

The device 400 includes a housing 402 with several output sections 404A, 404B, 404C, 404D, and 404E, which permit five players to use the housing 402 during a game. Each output section 404A-E includes three openings, such as openings 410, 412, and 414 of section 404C, that are defined by edges formed in the housing 402.

In one embodiment, a light diffusion mechanism, such as light diffusion mechanism 200 described above, is located in each output section 404A-E. The light emitting portions 354, 352, and 350 are positioned to be inserted into openings 410, 412, and 414, respectively. As discussed above, the light emitting portions 350, 352, and 354 are associated with respective chambers in which light from LEDs is reflected.

During an exemplary game play pattern, the LEDs in an output portion are illuminated in sequence. Initially, the LED associated with light emitting portion 354 is illuminated. Next, after a brief interval, the LED associated with light emitting portion 352 is illuminated. Then, after the same interval again, the LED associated with light emitting portion 350 is illuminated. The player for that output portion assesses the timing of the illuminations and taps the surface supporting the device near the housing 402 at the same interval after light emitting portion 350 is illuminated. The tap on the surface is detectable by a sensor in the housing 402. The electronic system then determines whether the tap was made within an appropriate time interval after the last illumination.

In different embodiments, the housing 402 may include a different quantity of output sections and the quantity of openings per output section may vary.

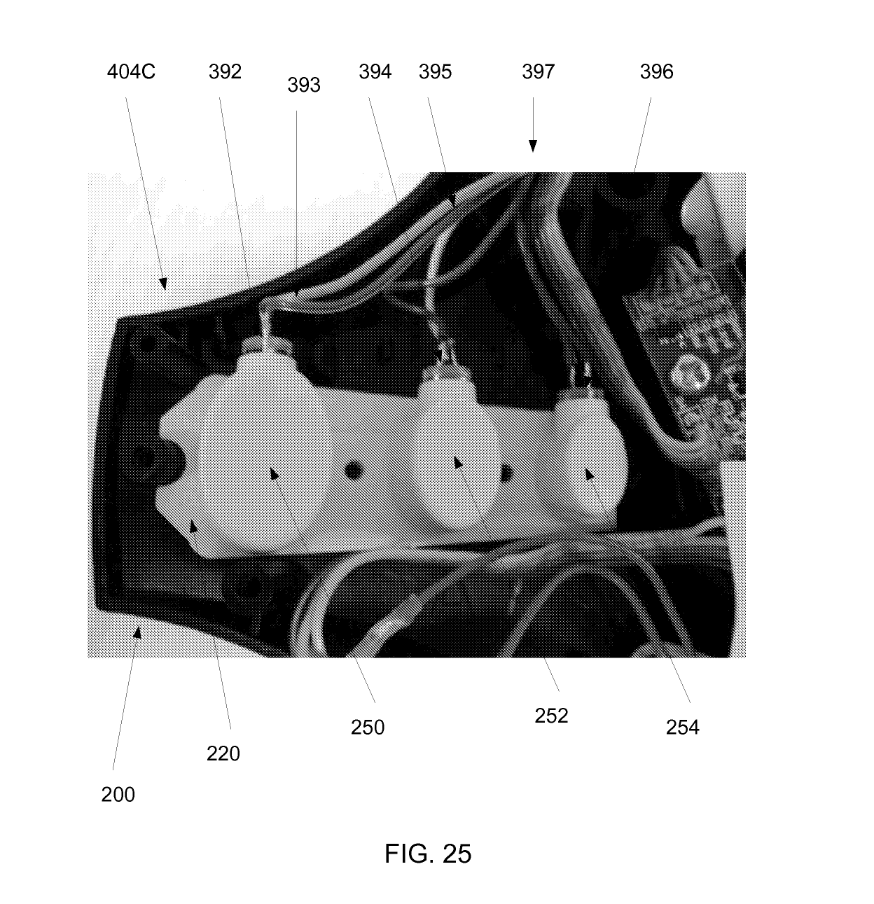

Referring to FIG. 25, a lower portion of the housing 402 has been removed from the upper portion of the housing 402, thereby exposing the interior of the device 400 and some of its components. The device 400 includes a light diffusion mechanism 200 located proximate to output portion 404C. The plate 220 and containers 250, 252, and 254 of the light diffusion mechanism 200 are illustrated. In addition, LEDs 392, 394, and 396 are inserted into the sleeves of containers 250, 252, and 254, respectively. Wires 393, 395, and 397 are connected to LEDs 392, 394, and 396, respectively.

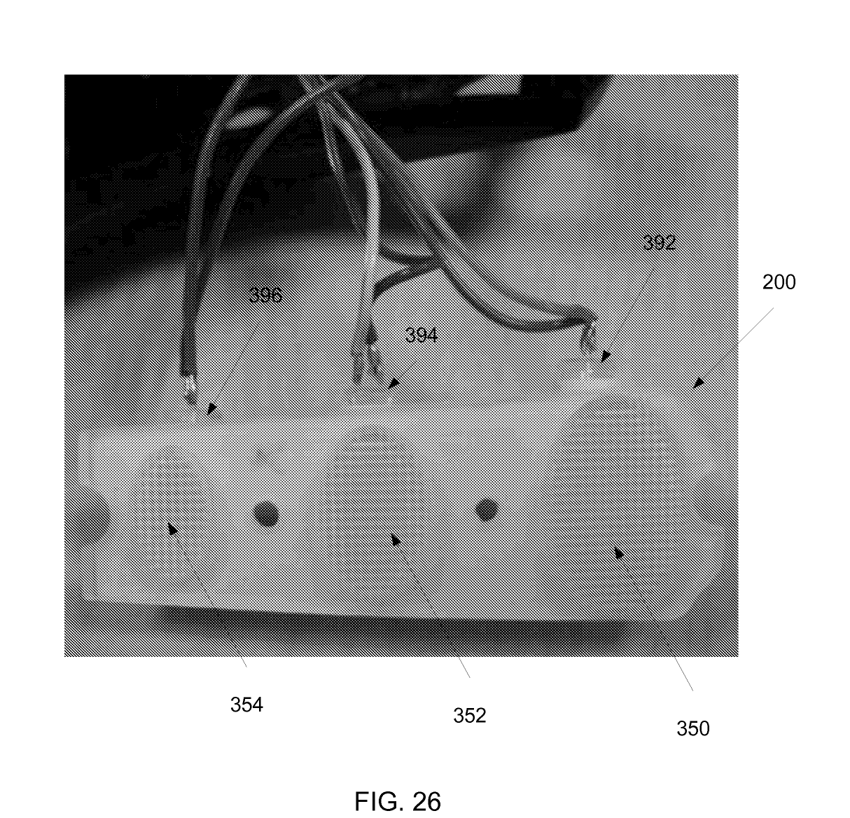

Referring to FIG. 26, the light diffusion mechanism 200 has been removed from the housing 402 and the light emitting portions 350, 352, and 354 are illustrated. The cross-hatched pattern that is shown in FIG. 26 is a function of the arrangement of orthogonal ridges and grooves on the inner surface and the outer surface of each of the light emitting portions 350, 352, and 354. The LEDs 392, 394, and 396 are shown as being inserted into their corresponding sleeves.

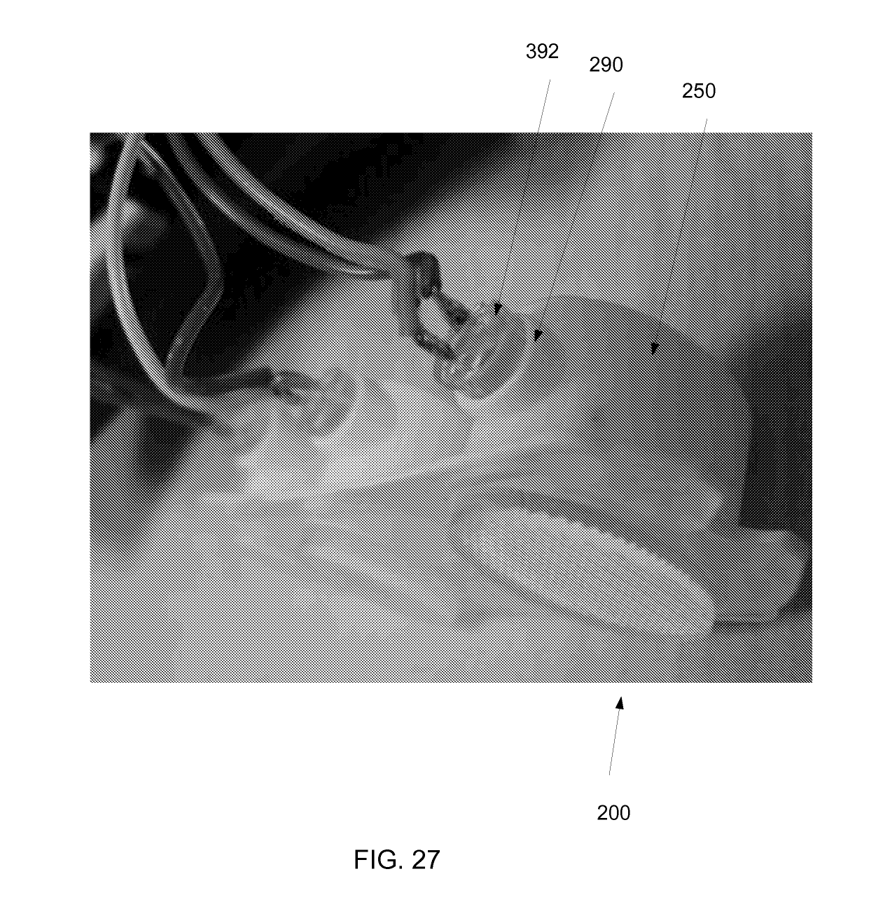

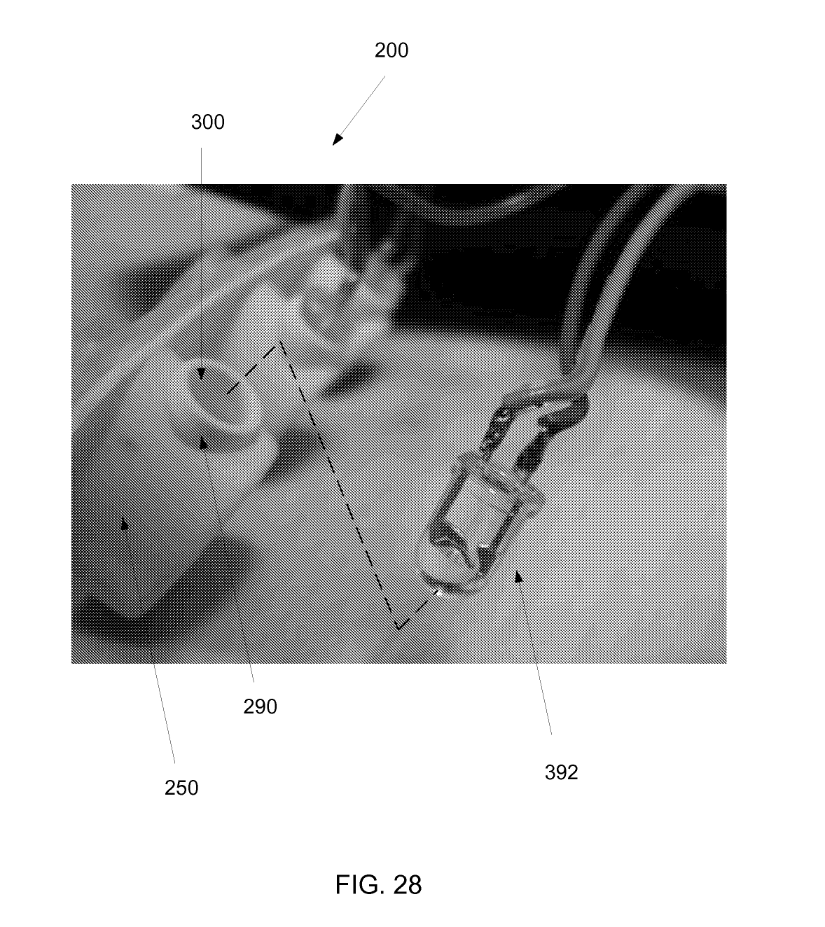

Referring to FIGS. 27 and 28, the interaction of the LED 392 with the container 250 of light diffusion mechanism is illustrated. In FIG. 27, the LED 392 is inserted into the sleeve 290 of container 250, and as a result, seals the passageway of sleeve 290. In FIG. 28, the LED 392 is removed from the sleeve 290, thereby exposing the passageway 300 that is in communication with the chamber of container 250.

In an alternative embodiment, multiple LEDs may be located in a chamber or receptacle of a container of a light diffusion mechanism.

In another embodiment, a single LED may be used with light-piping that is in communication with multiple containers. One end of each of the sections of light piping is located proximate to a receptacle of one of the containers. The LED can be located proximate to the opposite ends of the light piping.

It is to be understood that terms such as “left,” “right,” “top,” “bottom,” “front,” “end,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

Although the disclosed inventions are illustrated and described herein as embodied in one or more specific examples, it is nevertheless not intended to be limited to the details shown, since various modifications and structural changes may be made therein without departing from the scope of the inventions. In addition, various features from one of the embodiments may be incorporated into another of the embodiments. Accordingly, it is appropriate that the invention be construed broadly and in a manner consistent with the scope of the disclosure.

Exemplary descriptions of the present invention include the following.

In one embodiment, the invention includes a light diffusion chamber comprising a housing with a first opening and a second opening; a light source proximate to the first opening, the housing receiving light from the light source; and a diffusion panel covering the second opening.

In another embodiment, the invention relates to the light diffusion chamber in paragraph [00100] above, wherein the diffusion panel includes a first surface having a first light control pattern and a second surface having a second light control pattern.

In another embodiment, the invention relates to the light diffusion chamber in paragraph [00100] above, wherein the first surface of the diffusion panel is on an opposite side of the diffusion panel from the second surface.

In another embodiment, the invention relates to the light diffusion chamber in paragraph [00100] above, wherein the first light control pattern includes a plurality of grooves and ridges formed in the first surface of the diffusion panel, and the light exiting the second opening is incident upon the first light control pattern.

In another embodiment, the invention relates to the light diffusion chamber in paragraph [00100] above, wherein the second light control pattern includes a plurality of grooves and ridges formed in the second surface of the diffusion panel, and the grooves and ridges of the second light control pattern are oriented along a direction different than the direction along which the grooves and ridges of the first light control pattern are aligned.

In another embodiment, the invention relates to the light diffusion chamber in paragraph [00100] above, wherein the housing includes a wall with an upper end extending therefrom and the diffusion panel includes a groove that receives the upper end of the wall.

In another embodiment, the invention relates to the light diffusion chamber in paragraph [00100] above, wherein the housing is substantially cylindrical.

In another embodiment, the invention relates to the light diffusion chamber in paragraph [00100] above, wherein the housing includes a side wall with an upper end and a lower end, the housing includes a bottom wall coupled to the lower end of the side wall, and the first opening is formed in the side wall and the second opening is proximate to the upper end of the side wall.

In another embodiment, the invention relates to the light diffusion chamber in paragraph [00107] above, wherein the housing includes a sleeve coupled to the side wall, the sleeve defining a passageway in communication with the first opening.

In another embodiment, the invention relates to the light diffusion chamber in paragraph [00108] above, wherein the sleeve extends outwardly from the housing.

In another embodiment, the invention relates to the light diffusion chamber in paragraph [00100] above, wherein the housing includes a sleeve, the sleeve defines a passageway in communication with an interior of the housing.

In another embodiment, the invention relates to the light diffusion chamber in paragraph [00110] above, wherein the light source fills the passageway of the sleeve.

In another embodiment, the invention relates to the light diffusion chamber in paragraph [00110] above, wherein the light source is mounted in the sleeve and has a central axis, the central axis extending substantially parallel to the diffusion panel.

In another embodiment, the invention relates to the light diffusion chamber in paragraph [00110] above, wherein the light source is mounted in the sleeve and has a central axis, the central axis extending at an angle offset from a substantially horizontal orientation.

In another embodiment, the invention relates to the light diffusion chamber in paragraph [00110] above, wherein the light source is mounted in the sleeve and angled offset from the axis of the sleeve.

In another embodiment, the invention relates to the light diffusion chamber in paragraph [00110] above, wherein a portion of the light source extends from the sleeve into the interior of the housing and a portion of the light source is located in the passageway.

In another embodiment, the invention relates to the light diffusion chamber in paragraph [00110] above, wherein a center point of the sleeve is at a location that is approximately forty percent of the length of a side wall of the housing as measured from a bottom wall of the housing.

In another embodiment, the invention relates to the light diffusion chamber in paragraph [00110] above, a center point of the sleeve is located along a side wall of the housing at a distance that is approximately half of the length that the side wall of the housing extends from the diffusion panel.

In another embodiment, the invention relates to the light diffusion chamber in paragraph [00100] above, wherein the housing is a first housing, the light source is a first light source, and the chamber further comprises a plate coupled to the first housing; a second housing coupled to the plate, the second housing being spaced apart from the first housing, the second housing defining an opening; and a second light source operable to send light into the second housing, the light from the second light source exiting the opening of the second housing, the diffusion panel covering the opening of the second housing, the diffusion panel including a third surface having a third light control pattern and a fourth surface having a fourth light control pattern.

In another embodiment, the invention relates to the light diffusion chamber in paragraph [00118] above, wherein the third surface and the fourth surface are aligned with the opening of the second housing.

In another embodiment, the invention relates to the light diffusion chamber in paragraph [00118] above, wherein each of the first housing and the second housing is substantially cylindrical.

In another embodiment, the invention relates to the light diffusion chamber in paragraph [00118] above, wherein the first housing defines a first receptacle, the second housing defines a second receptacle, and the first receptacle has is wider than the second receptacle.

In another embodiment, the invention relates to the light diffusion chamber in paragraph [00118] above, wherein the first receptacle has a first length and the second receptacle has a second length, the first length being substantially the same as the second length.

In another embodiment, the invention relates to the light diffusion chamber in paragraph [00118] above, wherein the first light control pattern is oriented along the same direction as the third light control pattern.

In another embodiment, the invention relates to the light diffusion chamber in paragraph [00118] above, wherein the first light control pattern is oriented along the same direction as the third light control pattern, and the second light control pattern is oriented along the same direction as the fourth light control pattern.

In another embodiment, the invention relates to the light diffusion chamber in paragraph [00118] above, wherein the fourth surface is on an opposite side of the diffusion panel from the third surface, and the light from the second light source is incident on the third surface of the diffusion panel.

In another embodiment, the invention relates to the light diffusion chamber in paragraph [00118] above, wherein the plate is coupled to the diffusion panel via a connector.

In an alternative embodiment, the invention relates to an electronic device for use by a user, comprising a body defining a body opening; an electronic system coupled to the housing; and a light diffusion chamber disposed in the housing, the light diffusion chamber including a housing with a first opening and a second opening; a light source operable to send light through the first opening, the light source being connected to the electronic system; and a diffusion panel covering the second opening.

In another embodiment, the invention relates to the electronic device in paragraph [00127] above, wherein the diffusion panel includes a first surface having a first light control pattern and a second surface having a second light control pattern, the second opening being substantially aligned with the body opening in the body.

In another embodiment, the invention relates to the electronic device in paragraph [00128] above, wherein the first surface is frosted.

In another embodiment, the invention relates to the electronic device in paragraph [00127] above, wherein the light from the light source passes through the diffusion panel and exits the body of the electronic device via the body opening.

In another embodiment, the invention relates to the electronic device in paragraph [00127] above, wherein the housing is a first housing, the light source is a first light source, the body opening is a first body opening, the body includes a second body opening separate from the first body opening, and the chamber further comprises a plate coupled to the first housing; a second housing coupled to the plate, the second housing being spaced apart from the first housing; and a second light source operable to send light into the second housing, the light from the second light source exiting an opening of the second housing, the diffusion panel covering the opening of the second housing, the diffusion panel including a third surface having a third light control pattern and a fourth surface having a fourth light control pattern, at least a portion of the light from the second light source exiting the body via the second body opening.

What is claimed is:

1. A light diffusion chamber, comprising:
a chamber housing including a side wall with an upper end and a lower end, a bottom wall coupled to the lower end, a first opening formed in the side wall, a second opening proximate to the upper end of the side wall, and a sleeve coupled to the side wall, the sleeve defining a passageway in communication with an interior of the chamber housing via the first opening;
a light source proximate to the first opening, the chamber housing receiving light from the light source; and
a diffusion panel covering the second opening.

2. The light diffusion chamber of claim 1, wherein the diffusion panel includes a first surface having a first light control pattern and a second surface having a second light control pattern.

3. The light diffusion chamber of claim 2, wherein the first light control pattern includes a plurality of grooves and ridges formed in the first surface of the diffusion panel, and the light exiting the second opening is incident upon the first light control pattern.

4. The light diffusion chamber of claim 3, wherein the second light control pattern includes a plurality of grooves and ridges formed in the second surface of the diffusion panel, and the grooves and ridges of the second light control pattern are oriented along a direction different than the direction along which the grooves and ridges of the first light control pattern are aligned.

5. The light diffusion chamber of claim 1, wherein the diffusion panel includes a groove that receives the upper end of the side wall.

6. The light diffusion chamber of claim 1, wherein the sleeve extends outwardly from the chamber housing.

7. The light diffusion chamber of claim 1, wherein the light source is mounted in the sleeve and has a central axis, the central axis extending substantially parallel to the diffusion panel.

8. The light diffusion chamber of claim 1, wherein the light source is mounted in the sleeve and angled offset from the axis of the sleeve.

9. The light diffusion chamber of claim 1, wherein the light source is contained substantially within the sleeve.

10. The light diffusion chamber of claim 1, wherein the chamber housing is a first chamber housing, the light source is a first light source, and the light diffusion chamber further comprises:
a plate coupled to the first chamber housing;
a second chamber housing coupled to the plate, the second chamber housing being spaced apart from the first chamber housing, the second chamber housing defining an opening; and
a second light source operable to send light into the second chamber housing, the light from the second light source exiting the opening of the second chamber housing, the diffusion panel covering the opening of the second chamber housing, the diffusion panel including a third surface having a third light control pattern and a fourth surface having a fourth light control pattern.

11. The light diffusion chamber of claim 10, wherein the third surface and the fourth surface are aligned with the opening of the second chamber housing.

12. The light diffusion chamber of claim 10, wherein the first chamber housing defines a first receptacle, the second chamber housing defines a second receptacle, and the first receptacle is wider than the second receptacle.

13. The light diffusion chamber of claim 10, wherein the first receptacle has a first length and the second receptacle has a second length, the first length being substantially the same as the second length.

14. An electronic device for use by a user, comprising:
a device housing including a device housing body defining a body opening;
an electronic system coupled to the device housing; and
a light diffusion chamber disposed in the device housing, the light diffusion chamber including:
a chamber housing with a side wall, a bottom wall coupled to a bottom end of the side wall, a first opening formed in the side wall, a second opening proximate to an upper end of the side wall, and a sleeve coupled to the side wall;
a light source operable to send light through the first opening into the chamber housing, the light source being connected to the electronic system; and
a diffusion panel covering the second opening.

15. The electronic device of claim 14, wherein the diffusion panel includes a first surface having a first light control pattern and a second surface having a second light control pattern, the second opening being substantially aligned with the body opening in the device housing body.

16. The electronic device of claim 15, wherein the first surface is frosted.

17. The electronic device of claim 14, wherein the light from the light source passes through the diffusion panel and exits the device housing body of the electronic device via the body opening.

18. The electronic device of claim 14, wherein the chamber housing is a first chamber housing, the light source is a first light source, the body opening is a first body opening, the device housing body includes a second body opening separate from the first body opening, and the light diffusion chamber further comprises:
a plate coupled to the first chamber housing;
a second chamber housing coupled to the plate, the second chamber housing being spaced apart from the first chamber housing; and
a second light source operable to send light into the second chamber housing, the light from the second light source exiting an opening of the second chamber housing, the diffusion panel covering the opening of the second chamber housing, the diffusion panel including a third surface having a third light control pattern and a fourth surface having a fourth light control pattern, at least a portion of the light from the second light source exiting the body via the second body opening.

19. A light diffusion chamber, comprising:
a housing with a side wall with opposite upper and lower ends, a bottom wall coupled to the lower end, a first opening formed in the side wall, a second opening located proximate to the upper end of the side wall, and a mounting structure coupled to the side wall, the mounting structure being in communication with the first opening and an interior of the housing;
a light source coupled to the mounting structure and located proximate to the first opening, the housing receiving light from the light source; and
a diffusion panel covering the second opening.

20. The light diffusion chamber of claim 19, wherein the housing is a first housing, the light source is a first light source, and the light diffusion chamber further comprises:
a plate coupled to the first housing;
a second housing coupled to the plate, the second housing being spaced apart from the first housing, the second housing defining an opening, the second housing having a different configuration than the first housing; and
a second light source operable to send light into the second housing, the light from the second light source exiting the opening of the second housing, the diffusion panel covering the opening of the second housing, the diffusion panel including a third surface having a third light control pattern and a fourth surface having a fourth light control pattern different than the third light control pattern.
